(19) United States
(12) Patent Application Publication
(10) Pub. No.: US 2026/0100456 A1
(43) Pub. Date: Apr. 9, 2026

(54) ELECTRICITY STORAGE DEVICE

(71) Applicant: Prime Planet Energy & Solutions, Inc., Tokyo (JP)

(72) Inventors: Kuanhua HUANG, Okazaki-shi (JP); Yuta ORIHARA, Toyota-shi (JP)

(21) Appl. No.: 19/347,714

(22) Filed: Oct. 2, 2025

(30) Foreign Application Priority Data
Oct. 7, 2024 (JP) 2024-176153

(51) Int. Cl. H01M 50/15; H01M 50/103; H01M 50/169

(52) U.S. Cl. CPC H01M 50/15; H01M 50/103; H01M 50/169

(57) ABSTRACT

The present disclosure provides an electricity storage device that includes a case and an electrode assembly accommodated in the case. The case includes a case body having an opening surrounded by side walls including a pair of first walls, and a lid configured to seal the opening. The electrode assembly includes a laminated part formed by laminating a positive electrode and a negative electrode in an insulated state in a direction toward the lid. The lid includes a base part and a pair of first bent parts extending from the base part along the pair of first walls of the case body, the pair of first bent parts facing each other. At least one of the pair of first bent parts is joined to at least one of the pair of first walls of the case body via a first welding joining part.

### CROSS REFERENCE TO RELATED APPLICATION

This application claims the benefit of priority to Japanese Patent Application No. 2024-176153 filed on Oct. 7, 2024. The entire contents of this application are hereby incorporated herein by reference.

### BACKGROUND OF THE DISCLOSURE

The present disclosure relates to an electricity storage device.

Japanese Patent Laid-Open No. 2013-171729 discloses an power storage device container that includes a body member and a lid member, the body member having an opening part, the lid member including an insertion part inserted into the body member through the opening part. A multilayered electrode assembly accommodated in the power storage device container is pushed by both the insertion part and the body member. Thus, it is possible to achieve a preferred uniform separation distance between respective electrode sheets that constitute the electrode assembly.

### SUMMARY

There may be cases in which an electrode assembly expands during charging/discharging, for example. When the electrode assembly expands, the electrode assembly may apply a force that pushes the inner surfaces of a case toward the outside of the case. Consequently, stress is generated in the case, so that the case may be damaged. Particularly, in recent years, a material with a high expansion coefficient tends to be used for the electrode assembly to increase energy density. For this reason, there is a demand for increasing strength of the case.

One aspect of a technique disclosed herein is directed to an electricity storage device including a case and an electrode assembly accommodated in the case. The case includes a case body having an opening that is surrounded by side walls including a pair of first walls, and a lid configured to seal the opening. The electrode assembly includes a laminated part formed by laminating a positive electrode and a negative electrode in an insulated state in a direction toward the lid. The lid includes a base part, and a pair of first bent parts extending from the base part along the pair of first walls of the case body, the pair of first bent parts facing each other. A first bent part of the pair of first bent parts is joined to a first wall of the pair of first walls of the case body via a first welding joining part.

In the above-described electricity storage device, the strength of the case is increased.

### BRIEF DESCRIPTION OF THE DRAWINGS

FIG. 1 is an exploded view schematically showing the configuration of an electricity storage device according to one embodiment;

FIG. 2 is a schematic view showing the internal structure of the electricity storage device according to one embodiment;

FIG. 3 is a schematic view showing the internal structure of the electricity storage device according to one embodiment, as viewed from a direction different from that of FIG. 2;

FIG. 4 is a perspective view of a lid shown in FIG. 1 as viewed from the back side;

FIG. 5 is a schematic view showing the structure of an electrode assembly according to one embodiment.

FIG. 6 is a schematic view of an electricity storage device of a modification that corresponds to FIG. 3; and

FIG. 7 is a schematic view of the electricity storage device of the modification that corresponds to FIG. 2.

### DETAILED DESCRIPTION

Hereinafter, some embodiments of the art disclosed herein will be described in detail with reference to drawings. Matters other than matters particularly mentioned in the present specification, and necessary for the implementation of the art disclosed herein (for example, the general configuration and manufacturing process of an electricity storage device that do not characterize the present disclosure) can be grasped as design matters of those skilled in the art based on the conventional art in this field. The present disclosure can be implemented based on the contents disclosed herein and common technical knowledge in the field.

In this specification, “electricity storage device” is a concept encompassing a device in which charge/discharge reactions occur through the transfer of charge carriers between a pair of electrodes (a positive electrode and a negative electrode). That is, the electricity storage device encompasses batteries, such as secondary batteries (for example, a lithium-ion secondary battery, a nickel-metal hydride battery, and a nickel-cadmium battery), and capacitors (physical batteries), such as a lithium ion capacitor and an electric double-layer capacitor.

In this specification, “substantially rectangular shape” encompasses shapes other than a complete rectangular shape (oblong shape). For example, “substantially rectangular shape” also encompasses a shape in which a corner part connecting the long side and the short side of a rectangular shape together is rounded, and a shape in which a notch is formed at a corner part.

In general, there is a known electricity storage device that includes a case and an electrode assembly, the case including a case body and a lid, the electrode assembly being accommodated in the case. A welding part is often provided at a boundary portion between the lid and the case body. There may be cases in which the electrode assembly expands during charging/discharging, for example. Particularly, the electrode assembly expands during charging. When the electrode assembly expands, the electrode assembly may apply a force that pushes the lid outward. In this case, the end portion of the lid receives a larger stress than the center portion of the lid. In the case in which the welding part is formed at the end portion of the lid to join the lid to the case body, stress concentrates on the welding part. The welding part has relatively low strength and hence, the case is easily damaged or deformed. In view of the above, the present disclosure provides a technique that increases the strength of the case. One aspect of the technique of the present disclosure provides an electricity storage device in which a case has strength that prevents the case from being easily damaged or deformed even when an electrode assembly expands.

### Electricity Storage Device

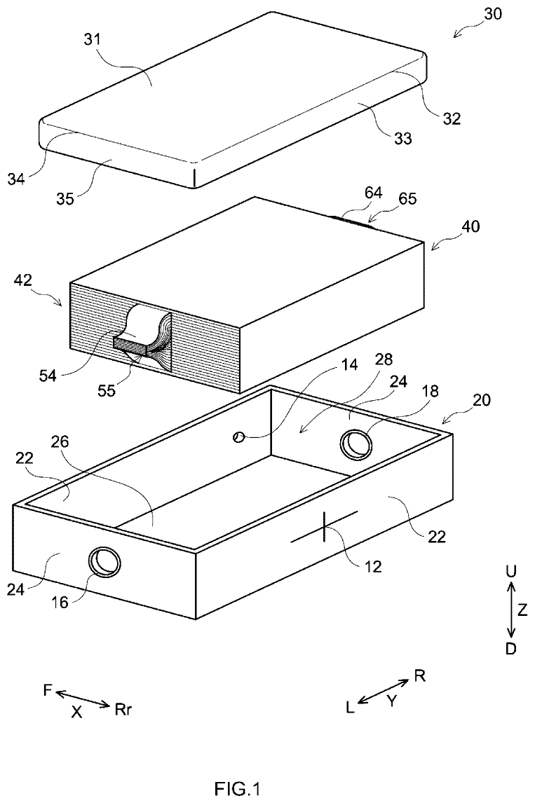

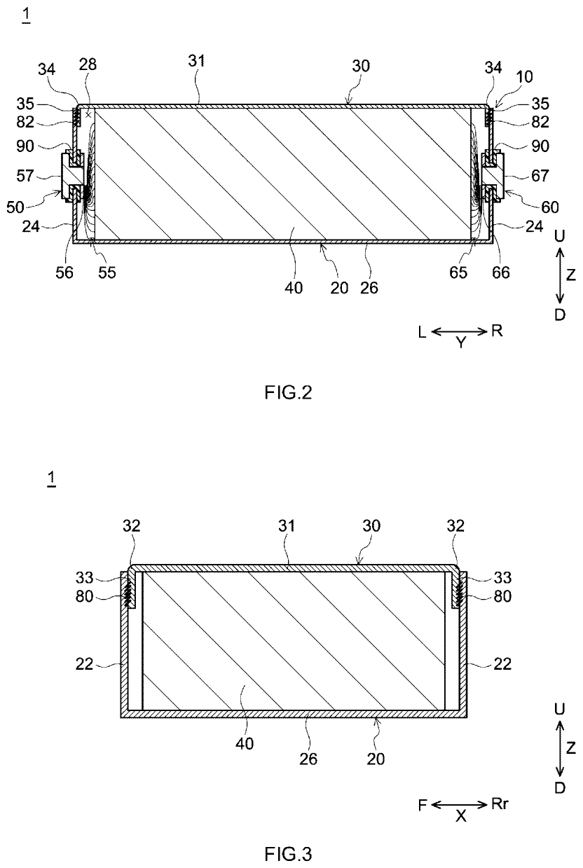

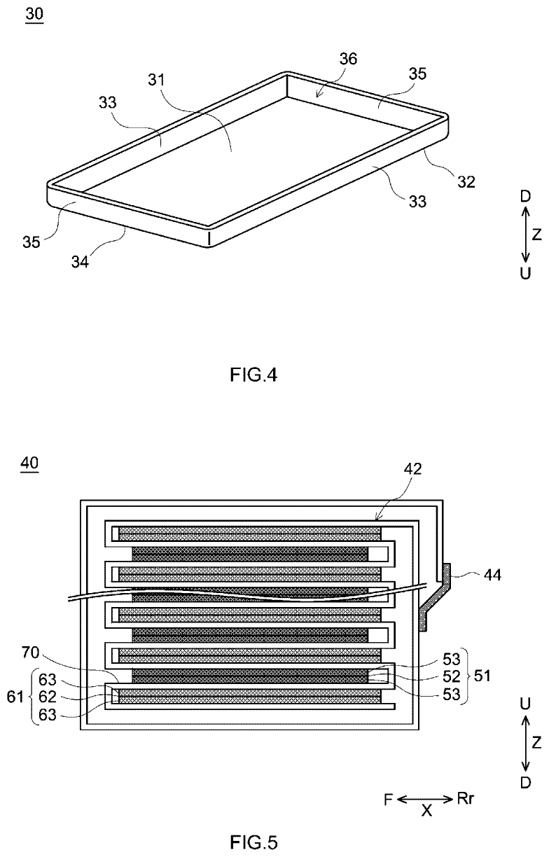

Hereinafter, an electricity storage device 1 will be described as one embodiment. FIG. 1 is an exploded view schematically showing the configuration of the electricity storage device according to one embodiment. FIG. 2 is a schematic view showing the internal structure of the electricity storage device according to one embodiment. FIG. 3 is a schematic view showing the internal structure of the electricity storage device according to one embodiment, as viewed from a direction different from that of FIG. 2. FIG. 4 is a perspective view of a lid shown in FIG. 1 as viewed from the back side. FIG. 5 is a schematic view showing the structure of an electrode assembly 40 according to one embodiment. Reference symbols “L”, “R”, “F”, “Rr”, “U”, and “D” in the drawings respectively denote “left”, “right”, “front”, “rear”, “up”, and “down”. Reference symbols “X”, “Y”, and “Z” in the drawings respectively denote the short-side direction of the electricity storage device 1, the longitudinal direction orthogonal to the short-side direction, and the up-down direction. However, these directions are merely given for the sake of convenience of description, and are not intended to limit the installation mode of the electricity storage device 1. The respective drawings are schematic, and the dimensional relationships (such as lengths, widths, and thicknesses) are not necessarily intended to represent actual dimensional relationships. In the drawings described below, the same reference symbols are given to members or parts having the same function, and the repeated description may be omitted or simplified.

As shown in FIG. 1 to FIG. 3, the electricity storage device 1 includes a case 10 and the electrode assembly 40. The electrode assembly 40 is accommodated in the case 10. In the present embodiment, the electricity storage device 1 is a lithium-ion secondary battery. The electricity storage device 1 includes a positive electrode 50, a negative electrode 60, and a nonaqueous electrolyte (not shown in the drawing). Hereinafter, respective configurations will be described.

### (1) Case

As shown in FIG. 1 to FIG. 3, the case 10 includes a case body 20 and a lid 30. The case body 20 has an opening 28 surrounded by side walls. The side walls of the case body 20 includes a pair of first walls 22 and a pair of second walls 24. The case body 20 includes a bottom wall 26 on the side opposite to the opening 28.

As shown in FIG. 1, the opening 28 is formed by being surrounded by the pair of long sides and the pair of short sides. In the present embodiment, the opening 28 has a substantially rectangular shape as viewed from above. In the present embodiment, the pair of first walls 22 forms the pair of long sides. Further, the pair of second walls 24 forms the pair of short sides. The opening 28 has a size that allows the electrode assembly 40 to be inserted into the case body 20. In some embodiments, the opening 28 may have a substantially square shape or a substantially polygonal shape as viewed from above.

As shown in FIG. 1 and FIG. 3, the pair of first walls 22 face each other in the short-side direction X. In the present embodiment, the first wall 22 has a larger area than the second wall 24. The first wall 22 has a substantially rectangular shape. The first wall 22 has a pair of long sides extending in a longitudinal direction Y, and has a pair of short sides extending in a height direction Z. In some embodiments, the first wall 22 may have a substantially square shape, or may have a substantially polygonal shape. The first wall 22 may have a substantially rectangular shape that has long sides extending in the height direction Z, and that has short sides extending in the longitudinal direction Y.

As shown in FIG. 1 and FIG. 2, the pair of second walls 24 face each other in the longitudinal direction Y. The pair of second walls 24 are disposed adjacent to the pair of first walls 22. In the present embodiment, the second wall 24 has a smaller area than the first wall 22. The second wall 24 has a substantially rectangular shape. The second wall 24 has a pair of long sides extending in the short-side direction X, and has a pair of short sides extending in the height direction Z. In some embodiments, the second wall 24 may have a substantially square shape, or may have a substantially polygonal shape. The second wall 24 may have a substantially rectangular shape that has long sides extending in the height direction Z, and that has short sides extending in the longitudinal direction Y.

As shown in FIG. 1 to FIG. 3, the bottom wall 26 is disposed on the side opposite to the opening 28 in the height direction Z. In the present embodiment, the bottom wall 26 has a substantially rectangular shape. The first walls 22 extend from the long sides of the bottom wall 26. The second walls 24 extend from the short sides of the bottom wall 26. In some embodiments, the bottom wall 26 may have a substantially square shape, or may have a substantially polygonal shape.

In some embodiments, a second opening may be formed instead of the bottom wall 26. That is, the case body 20 may be formed in a cylindrical shape having two openings. In this case, the second opening may be sealed by a second lid. The second lid may have a configuration similar to that of the lid 30.

The material of the case body 20 may be, for example, a metal material, such as aluminum, aluminum alloy, iron, or iron alloy. From the viewpoint of ease of processing, it is preferable that the case body 20 be made of aluminum or aluminum alloy. The case body 20 is manufactured by pressing a metal sheet, for example. The case body 20 may be formed of a plurality of members.

As shown in FIG. 2 and FIG. 3, the lid 30 is mounted on the opening 28 of the case body 20 to seal the opening 28. As shown in FIG. 1 to FIG. 4, the lid 30 includes a base part 31, first corner parts 32, and first bent parts 33. In the present embodiment, the lid 30 further includes second corner parts 34 and second bent parts 35.

The base part 31 is a main surface that covers the opening of the case body 20. As shown in FIG. 1 to FIG. 4, in the present embodiment, the base part 31 is a plate-like part. The base part 31 faces the bottom wall 26 of the case body 20. The base part 31 has a shape that corresponds to the opening 28, as viewed in a plan view. In the present embodiment, the base part 31 has a substantially rectangular shape, and has a pair of long sides and a pair of short sides.

As shown in FIG. 1, FIG. 3, and FIG. 4, the first corner parts 32 are located at the end portions of the base part 31. Each first corner part 32 is located between the base part 31 and the first bent part 33. In the present embodiment, the first corner parts 32 are a pair of long-side parts of the base part 31. In the present embodiment, the first corner parts 32 are located at positions inward of the opening 28 of the case body 20. The first corner parts 32 may be curved (rounded) or angular. From the viewpoint of increasing the strength of the first corner part 32, it is preferable that the first corner part 32 not include a welding mark (welding part).

As shown in FIG. 3, the pair of first bent parts 33 is located at both ends of the base part 31 in the short-side direction X. The pair of first bent parts 33 extends from the base part 31 along the pair of first walls 22 of the case body 20. The pair of first bent parts 33 face each other. In the present embodiment, each first bent part 33 extends along the first wall 22 from the first corner part 32, which is located at the end portion of the base part 31. The first bent part 33 is joined to the first wall 22 of the case body 20 via a first welding joining part 80. In the present embodiment, the first bent part 33 is in contact with the inner surface (the surface on the inner side of the case 10) of the first wall 22 of the case body 20. That is, the first bent part 33 is joined to the inner surface of the first wall 22 of the case body 20 via the first welding joining part 80.

As shown in FIG. 3, the first welding joining part 80 is formed by joining the first bent part 33 and the first wall 22 by welding. In the present embodiment, the first welding joining part 80 joins the first bent part 33 and the first wall 22 without forming a gap between the first bent part 33 and the first wall 22, the gap allowing communication between the inside and the outside of the case 10. The first welding joining part 80 is formed by irradiating, for example, the overlapping portion between the first bent part 33 and the first wall 22 with a laser from the outer surface of the first wall 22.

It is preferable that the length of the first bent part 33 in the height direction Z of the electricity storage device 1 be equal to or less than half the length of the first wall 22 in the height direction Z, and be equal to or less than one-third of the length of the first wall 22 in the height direction Z. Consequently, the arrangement of other members is less likely to be restricted in the inner pace of the case 10. It is also preferable that the length of the first bent part 33 be equal to or more than one-twentieth of the length of the first wall 22 in the height direction Z, and be equal to or more than one-tenth of the length of the first wall 22 in the height direction Z. Consequently, it is possible to achieve a large area of the first welding joining part 80 and hence, joining strength between the lid 30 and the case body 20 can be increased.

As shown in FIG. 1 to 3, the second corner parts 34 are located at the end portions of the base part 31. Each second corner part 34 is located between the base part 31 and the second bent part 35. In the present embodiment, the second corner parts 34 are a pair of short-side parts of the base part 31. In the present embodiment, the second corner parts 34 are located inward of the opening 28 of the case body 20. The second corner parts 34 may be curved (rounded) or angular. From the viewpoint of increasing the strength of the second corner part 34, it is preferable that the second corner part 34 not include a welding mark (welding part).

As shown in FIG. 2, the pair of second bent parts 35 is located at both ends of the base part 31 in the longitudinal direction Y. The pair of second bent parts 35 extends from the base part 31 along the pair of second walls 24 of the case body 20. The pair of second bent parts 35 face each other. In the present embodiment, each second bent part 35 extends along the second wall 24 from the second corner part 34, which is located at the end portion of the base part 31. The second bent part 35 is joined to the second wall 24 of the case body 20 via a second welding joining part 82. In the present embodiment, the second bent part 35 is in contact with the inner surface (the surface on the inner side of the case 10) of the second wall 24 of the case body 20. That is, the second bent part 35 is joined to the inner surface of the second wall 24 of the case body 20 via the second welding joining part 82. In the present embodiment, the second bent part 35 is formed contiguously with the first bent part 33. In some embodiments, a slit may be formed between the second bent part 35 and the first bent part 33.

As shown in FIG. 2, the second welding joining part 82 is formed by joining the second bent part 35 and the second wall 24 by welding. In the present embodiment, the second welding joining part 82 joins the second bent part 35 and the second wall 24 without forming a gap between the second bent part 35 and the second wall 24, the gap allowing communication between the inside and the outside of the case 10. The second welding joining part 82 is formed by irradiating, for example, the overlapping portion between the second bent part 35 and the second wall 24 with a laser from the outer surface of the second wall 24. In the present embodiment, the lid 30 is fixed to the case body 20 by the first welding joining parts 80 and the second welding joining parts 82, so that the opening 28 of the case body 20 is sealed.

It is preferable that the length of the second bent part 35 in the height direction Z of the electricity storage device 1 be equal to or less than half the length of the second wall 24 in the height direction Z, and be equal to or less than one-third of the length of the second wall 24 in the height direction Z. Consequently, the arrangement of other members is less likely to be restricted in the inner space of the case 10. It is also preferable that the length of the second bent part 35 be equal to or more than one-twentieth of the length of the second wall 24 in the height direction Z, and be equal to or more than one-tenth of the length of the second wall 24 in the height direction Z. Consequently, it is possible to achieve a large area of the second welding joining part 82 and hence, joining strength between the lid 30 and the case body 20 can be increased.

As shown in FIG. 4, the lid 30 includes a recessed part 36 surrounded by the base part 31, the first bent parts 33, and the second bent parts 35. The lid 30 includes the recessed part 36, thereby increasing the inner space of the case 10 that can be occupied by the electrode assembly 40. Consequently, a large capacity of the electricity storage device 1 can be achieved.

The material of the lid 30 may be, for example, a metal material, such as aluminum, aluminum alloy, iron, or iron alloy. From the viewpoint of ease of processing, it is preferable that the lid 30 be made of aluminum or aluminum alloy. The lid 30 is manufactured by pressing a metal sheet, for example. The lid 30 may also be manufactured by bending a metal sheet. For this reason, in this specification, “bent part” is not limited to a part formed by bending, and may be a part formed by other processing, such as pressing.

When the electrode assembly 40 of the electricity storage device 1 expands, the electrode assembly 40 may generate a force that pushes the lid 30 toward the outside of the case 10. Consequently, relatively large stress is generated also in the lid 30 at the first corner parts 32, which are the end portions of the base part 31. For this reason, in the electricity storage device 1, the lid 30 is joined to the first walls 22 of the case body 20 via the first welding joining parts 80. Consequently, it is possible to prevent stress from being concentrated on the first welding joining parts 80. As a result, it is possible to increase the strength of the case 10.

When the electrode assembly 40 of the electricity storage device 1 expands, stress may also be generated at the second corner parts 34 located on the short-side sides of the base part 31. For this reason, it is also preferable that the lid 30 be joined to the second walls 24 of the case body 20 via the second welding joining parts 82 on the short-side sides of the base part 31. Consequently, it is possible to prevent stress from being concentrated on the second welding joining parts 82. As a result, it is possible to increase the strength of the case 10.

When the electrode assembly 40 expands, thus generating a force that pushes the lid 30 outward, relatively larger stress is generated on the long-side sides of the lid 30 than the short-side sides of the lid 30. For this reason, it is preferable that the first bent parts 33 be provided along the first walls 22 forming the long sides of the opening 28 of the case body 20.

As shown in FIG. 3, the first corner parts 32 of the lid 30 may be disposed at positions above the opening 28 of the case body 20 (on the side of the case body 20 away from the bottom wall 26). As shown in FIG. 2, the second corner parts 34 of the lid 30 may be disposed at positions above the opening 28 of the case body 20 (on the side of the case body 20 away from the bottom wall 26). With such a configuration, a large inner space of the case 10 can be ensured and hence, it is possible to achieve a large capacity of the electricity storage device 1.

As shown in FIG. 1, the case 10 includes a safety valve 12. In the present embodiment, the safety valve 12 is provided to the first wall 22. The safety valve 12 is a thin wall portion that is designed to rupture when the inside of the case 10 reaches a predetermined pressure, thereby releasing the internal pressure. In some embodiments, the safety valve 12 may be provided to the second wall 24, the bottom wall 26, or the lid 30. Two or more safety valves 12 may be provided. The safety valve 12 need not be provided.

As shown in FIG. 1, the case 10 has a pouring hole 14. The pouring hole 14 is a through hole that allows pouring of nonaqueous electrolyte into the case 10. The pouring hole 14 allows the inside and the outside of the case 10 to be in communication. In the present embodiment, the pouring hole 14 is provided to the first wall 22. In manufacture of the electricity storage device 1, electrolyte solution is poured into the case 10 through the pouring hole 14. After the electrolyte solution is poured, the pouring hole 14 is sealed by a sealing plug or the like. Consequently, the case 10 is hermetically sealed, so that leakage of the electrolyte solution is prevented. In some embodiments, the pouring hole 14 may be provided to the second wall 24, the bottom wall 26, or the lid 30. The pouring hole 14 need not be provided.

As shown in FIG. 1 and FIG. 2, the case 10 has a positive electrode terminal insertion hole 16 and a negative electrode terminal insertion hole 18. The positive electrode terminal insertion hole 16 and the negative electrode terminal insertion hole 18 allow the inside and the outside of the case 10 to be in communication. A positive electrode terminal 57 is attached to the positive electrode terminal insertion hole 16. A negative electrode terminal 67 is attached to the negative electrode terminal insertion hole 18. In the present embodiment, the positive electrode terminal insertion hole 16 is provided to one second wall 24. The negative electrode terminal insertion hole 18 is provided to the other second wall 24, which faces the one second wall 24. In some embodiments, the positive electrode terminal insertion hole 16 and the negative electrode terminal insertion hole 18 may be provided to the first walls 22, the bottom wall 26, or the lid 30. The positive electrode terminal insertion hole 16 and the negative electrode terminal insertion hole 18 may be provided to the same surface (wall).

### (2) Positive Electrode

The positive electrode 50 includes positive electrode plates 51, a positive electrode current collector 56, and the positive electrode terminal 57. The positive electrode plates 51 are electrically connected to the positive electrode current collector 56. The positive electrode current collector 56 is electrically connected to the positive electrode terminal 57.

As shown in FIG. 5, each positive electrode plate 51 includes a positive electrode current collector 52 and a positive electrode active material layer 53 fixedly mounted on at least one surface of the positive electrode current collector 52. The positive electrode plate 51 may have a sheet shape. The material of the positive electrode current collector 52 is a metal material having conductivity. The positive electrode current collector 52 is made of a metal foil, for example. Aluminum, aluminum alloy, or the like, for example, may be used as the material of the positive electrode current collector 52.

The positive electrode active material layer 53 contains a positive electrode active material. The positive electrode active material is a material that can reversibly absorb and release charge carriers. It is preferable that the positive electrode active material be an oxide containing at least one element selected from Ni, Co, Mn. Examples of the positive electrode active material include lithium transition metal complex oxides, such as a lithium cobaltate, a lithium manganate, a lithium nickelate, a lithium nickel manganese complex oxide, and a lithium nickel cobalt manganese complex oxide. It is more preferable that the positive electrode active material be a lithium composite oxide containing Ni (in other words, Ni-containing lithium composite oxide). In the Ni-containing lithium composite oxide, the Ni content may be, for example, 60 mol % or more and 100 mol % or less relative to the total number of mols of metals other than Li. In the lithium transition metal complex oxide, Ni, Co, or Mn may be partially substituted by Al, Ti, Zr, P, B, Si, Nb, C, or the like. The positive electrode active material may also be a lithium transition metal complex oxide the particle surface of which is covered with a compound containing Al, Ti, Zr, W, P, B, Si, Nb, C, or the like. The amount of substitution and the amount of addition may be approximately 0.1 to 7 mass % in total. It is also possible to use, as the positive electrode active material, a lithium transition metal phosphate compound, such as lithium iron phosphate. The positive electrode active material layer 53 may contain a conductive material, a binder, or the like. It is preferable that a carbon material, such as carbon black or carbon nanotube, be used as the conductive material. It is preferable that a resin binder, such as polyvinylidene fluoride, be used as the binder.

As shown in FIG. 2, positive electrode tabs 54 are provided at the end portions of the positive electrode current collectors 52 in an extending manner. Each positive electrode tab 54 includes, at least at a portion thereof, a positive electrode current collector exposed portion in which the surface of the positive electrode current collector 52 is exposed. A positive electrode connection part 55 is formed by overlapping the plurality of positive electrode tabs 54 with each other. The positive electrode connection part 55 is formed by joining, for example, the positive electrode current collector exposed portions of the plurality of positive electrode tabs 54 by, for example, ultrasonic joining, laser welding, or the like. In the present embodiment, the positive electrode connection part 55 is disposed at the position that faces the second wall 24 having the positive electrode terminal insertion hole 16. The positive electrode tabs 54 need not extend from the end portions of the positive electrode current collectors 52. For example, the positive electrode current collector exposed portions having a strip shape may be provided at the end portions of the positive electrode current collectors 52 as the positive electrode tabs 54.

As shown in FIG. 2, the positive electrode current collector 56 is electrically connected to the positive electrode connection part 55. The positive electrode current collector 56 may be made of a metal material. The positive electrode current collector 56 may be formed of, for example, a metal member having conductivity. The positive electrode current collector 56 is formed of, for example, one or two or more plate-shaped metal members. It is preferable that the positive electrode current collector 56 be made of, for example, the same material as the positive electrode current collectors 52. The positive electrode current collector 56 may be made of, for example, aluminum, aluminum alloy, or the like. The positive electrode current collector 56 and the positive electrode connection part 55 are joined to each other by, for example, ultrasonic joining, laser welding, or resistance welding.

As shown in FIG. 2, the positive electrode terminal 57 is attached to the case 10 in a state of being mounted in the positive electrode terminal insertion hole 16. A portion of the positive electrode terminal 57 is exposed to the outside of the case 10. The positive electrode terminal 57 is preferably made of metal, and more preferably made of aluminum or aluminum alloy, for example. The positive electrode terminal 57 is electrically connected to the positive electrode current collector 56 in the case 10. Consequently, the positive electrode terminal 57 is electrically connected to the positive electrode plates 51. The positive electrode terminal 57 and the positive electrode current collector 56 are joined to each other by, for example, caulking, ultrasonic joining, laser welding, or resistance welding. In some embodiments, the positive electrode current collector 56 and the positive electrode terminal 57 may be formed as one member.

As shown in FIG. 2, an insulating member 90 is disposed between the positive electrode terminal 57 and the case 10 (to be more specific, the second wall 24). Consequently, conduction between the positive electrode terminal 57 and the case 10 is prevented. The insulating member 90 may be made of, for example, a polyolefin resin, such as polypropylene (PP) or polyethylene (PE), a fluorinated resin, such as tetrafluoroethylene-perfluoroalkoxyethylene copolymer (PFA), or a polyphenylene sulfide (PPS).

### (3) Negative Electrode

The negative electrode 60 includes negative electrode plates 61, a negative electrode current collector 66, and the negative electrode terminal 67. The negative electrode plates 61 are electrically connected to the negative electrode current collector 66. The negative electrode current collector 66 is electrically connected to the negative electrode terminal 67.

As shown in FIG. 5, each negative electrode plate 61 includes a negative electrode current collector 62 and a negative electrode active material layer 63 fixedly mounted on at least one surface of the negative electrode current collector 62. The negative electrode plate 61 may have a sheet shape. The material of the negative electrode current collector 62 is a metal material having conductivity. The negative electrode current collector 62 is made of a metal foil, for example. Copper, copper alloy, or the like, for example, may be used as the material of the negative electrode current collector 62.

The negative electrode active material layer 63 contains a negative electrode active material. The negative electrode active material is a material that can reversibly absorb and release charge carriers. Examples of the negative electrode active material include a carbon-based negative electrode active material, such as graphite, hard carbon, and soft carbon; a Si-containing negative electrode active material, such as Si and silicon oxide; a silicon-carbon composite negative electrode active material; and a Sn-based negative electrode active material, such as Sn. The negative electrode active material layer 63 may contain a conductive material, a thickener, a binder, or the like. It is preferable that the negative electrode active material layer 63 contain styrene-butadiene rubber, carboxymethylcellulose, or the like as the binder.

In some embodiments, the Si-containing negative electrode active material is adopted as the negative electrode active material. The Si-containing negative electrode active material has a higher theoretical volumetric energy density than the carbon-based negative electrode active material. However, the Si-containing negative electrode active material exhibits a larger volume change during charging/discharging than the carbon-based negative electrode active material. Consequently, there is a possibility that the electrode assembly 40 has a high expansion coefficient, thereby increasing the force that pushes the case 10 from the inner side toward the outer side, so that the case may be deformed or damaged. With the technique of the present disclosure, the case has high strength and hence, it is possible to reduce a possibility of deformation or damage of the case even in the case in which a material having a large volume change is adopted, such as the Si-containing negative electrode active material.

As shown in FIG. 2, negative electrode tabs 64 are provided at the end portions of the negative electrode current collectors 62 in an extending manner. Each negative electrode tab 64 includes, at least at a portion thereof, a negative electrode current collector exposed portion in which the surface of the negative electrode current collector 62 is exposed. A negative electrode connection part 65 is formed by overlapping the plurality of negative electrode tabs 64 with each other. The negative electrode connection part 65 is formed by joining, for example, the negative electrode current collector exposed portions of the plurality of negative electrode tabs 64 by, for example, ultrasonic joining, laser welding, or the like. In the present embodiment, the negative electrode connection part 65 is disposed at the position that faces the second wall 24 having the negative electrode terminal insertion hole 18. The negative electrode tabs 64 need not extend from the end portions of the negative electrode current collectors 62. For example, the negative electrode current collector exposed portions having a strip shape may be provided at the end portions of the negative electrode current collectors 62 as the negative electrode tabs 64.

As shown in FIG. 2, the negative electrode current collector 66 is electrically connected to the negative electrode connection part 65. The negative electrode current collector 66 may be made of a metal material. The negative electrode current collector 66 may be formed of, for example, a metal member having conductivity. The negative electrode current collector 66 may be formed of, for example, one or two or more plate-shaped metal members. It is preferable that the negative electrode current collector 66 be made of, for example, the same material as the negative electrode current collectors 62. The negative electrode current collector 66 may be made of, for example, copper, copper alloy, or the like. The negative electrode current collector 66 and the negative electrode connection part 65 are joined to each other by, for example, ultrasonic joining, laser welding, or resistance welding.

As shown in FIG. 2, the negative electrode terminal 67 is attached to the case 10 in a state of being mounted in the negative electrode terminal insertion hole 18. A portion of the negative electrode terminal 67 is exposed to the outside of the case 10. The negative electrode terminal 67 is preferably made of metal, and more preferably made of copper or copper alloy, for example. The negative electrode terminal 67 is electrically connected to the negative electrode current collector 66 in the case 10. Consequently, the negative electrode terminal 67 is electrically connected to the negative electrode plates 61. The negative electrode terminal 67 and the negative electrode current collector 66 are joined to each other by, for example, caulking, ultrasonic joining, laser welding, or resistance welding. In some embodiments, the negative electrode current collector 66 and the negative electrode terminal 67 may be formed as one member.

As shown in FIG. 2, an insulating member 90 is disposed between the negative electrode terminal 67 and the case 10 (to be more specific, the second wall 24). Consequently, conduction between the negative electrode terminal 67 and the case 10 is prevented.

### (4) Electrode Assembly

The electrode assembly 40 is a power generating element of the electricity storage device 1. In the electrode assembly 40, the positive electrodes 50 and the negative electrodes 60 are laminated in an insulated state. In the present embodiment, as shown in FIG. 5, the electrode assembly 40 includes the positive electrode plates 51, the negative electrode plates 61, and a separator 70. The positive electrode plates 51 and the negative electrode plates 61 form a laminated part 42 in which the positive electrode plates 51 and the negative electrode plates 61 are alternately laminated with the separator 70 interposed therebetween. In the case 10, the electrode assembly 40 is disposed such that the lamination direction of the laminated part 42 is directed toward the lid 30. The positive electrode plates 51 and the negative electrode plates 61 are formed in a substantially rectangular shape as viewed in a plan view.

A volume change is likely to occur in the laminated part 42 especially in the lamination direction during charging/discharging of the electrode assembly 40. Therefore, in the case in which the electrode assembly 40 is disposed in the electricity storage device 1 such that the lamination direction of the laminated part 42 is directed toward the lid 30, a large force that pushes the lid 30 outward is generated in the electricity storage device 1 when the electrode assembly 40 expands. With the technique of the present disclosure, the case 10 has increased strength and hence, it is possible to reduce the possibility of damage or deformation of the case 10 even with the above-described configuration.

As shown in FIG. 5, in the present embodiment, the separator 70 has a zigzag shape (also referred to as “bellows shape”) in which the separator 70 is alternately folded at predetermined intervals. The surfaces of each of the electrode plates (the positive electrode plates 51 and the negative electrode plates 61) in the thickness direction (lamination direction) are interposed between folded portions of the separator 70. The separator 70 is wound around the outermost peripheral portion of the zigzag structure, thus forming the outer peripheral surface of the electrode assembly 40. A winding stop tape 44 is attached to the terminal portion of the separator 70 to prevent the winding from loosening.

The separator 70 may have a configuration similar to that of the conventional technique, and is not particularly limited. The separator 70 may have a single-layer structure, or a structure with two or more layers having different properties or characteristics (such as thickness or porosity), for example, a three-layer structure. It is preferable that the separator 70 be made of a resin, for example, a polyolefin resin. It is preferable to use polyethylene, polypropylene, or a mixture thereof as the polyolefin resin.

To prevent conduction between the electrode assembly 40 and the case 10, an electrode assembly holder (not shown in the drawing) having insulating property may be disposed between the electrode assembly 40 and the case 10. The material of the electrode assembly holder may be, for example, a polyamide resin or a polyolefin resin (for example, polypropylene or polyethylene).

It is preferable that, the base part 31 of the lid 30 be in direct or indirect contact with the electrode assembly 40 in the lamination direction of the laminated part 42 of the electrode assembly 40. It is more preferable that the electrode assembly 40 be in direct or indirect contact with the base part 31 of the lid 30 when the electrode assembly 40 is in a discharge state (for example, SOC is 20% or less). With such a configuration, the lid 30 can apply confining pressure to the electrode assembly 40 from the lamination direction. Consequently, when the electricity storage device 1 is used as a battery constituting a battery module, it is possible to reduce or eliminate confining pressure applied by an external member. Thus, an example of a method for manufacturing the electricity storage device 1 includes joining the lid 30 to the case body 20 by welding while the electrode assembly 40 accommodated in the case body 20 is pushed by the base part 31 of the lid 30 from the lamination direction. Note that the phrase “the base part 31 of the lid 30 indirectly contacts the electrode assembly 40” refers to a state in which the base part 31 of the lid 30 is in contact with the electrode assembly 40 via another member, thereby allowing the base part 31 to push the electrode assembly 40 via another member.

The thickness of the laminated part 42 of the electrode assembly 40 in the lamination direction may be larger than the height of the case body 20 in the height direction Z. This allows the base part 31 of the lid 30 to easily push the electrode assembly 40 from the lamination direction. Consequently, when the electricity storage device 1 is used as the battery constituting the battery module, it is possible to reduce or eliminate confining pressure applied by the external member.

### (5) Electrolyte Solution

The electrolyte solution may be the same as the conventionally used electrolyte solution, and is not particularly limited. The electrolyte solution is, for example, a nonaqueous electrolyte containing a nonaqueous solvent (organic solvent) and supporting salt (electrolyte salt, for example, lithium salt or sodium salt). Examples of the nonaqueous solvent include carbonates, such as ethylene carbonate, dimethyl carbonate, and ethyl methyl carbonate. Examples of the supporting salt include fluorine-containing lithium salt, such as lithium hexafluorophosphate (LiPF₆).

The electricity storage device 1 can be used in various applications. A preferred application is in-vehicle use, specifically, as a driving power source mounted in a vehicle, such as an electric vehicle (BEV), a hybrid electric vehicle (HEV), or a plug-in hybrid electric vehicle (PHEV). The electricity storage device 1 may also be used as a storage battery, for example, as a small-sized power storage device. The electricity storage device 1 may also be used in the form of a battery module in which a plurality of electricity storage devices are typically connected in series and/or in parallel.

Although some embodiments have been described above, these embodiments are merely illustrative. The technique of the present disclosure can be implemented in various modes. The art set forth in the scope of claims encompasses various modifications and alterations of the embodiments illustrated above. For example, a part of the above-described embodiment may be replaced with an alternative embodiment, or an alternative embodiment may be added to the above-described embodiment. Further, if a technical feature is not described as an essential technical feature, such a technical feature may be deleted when appropriate.

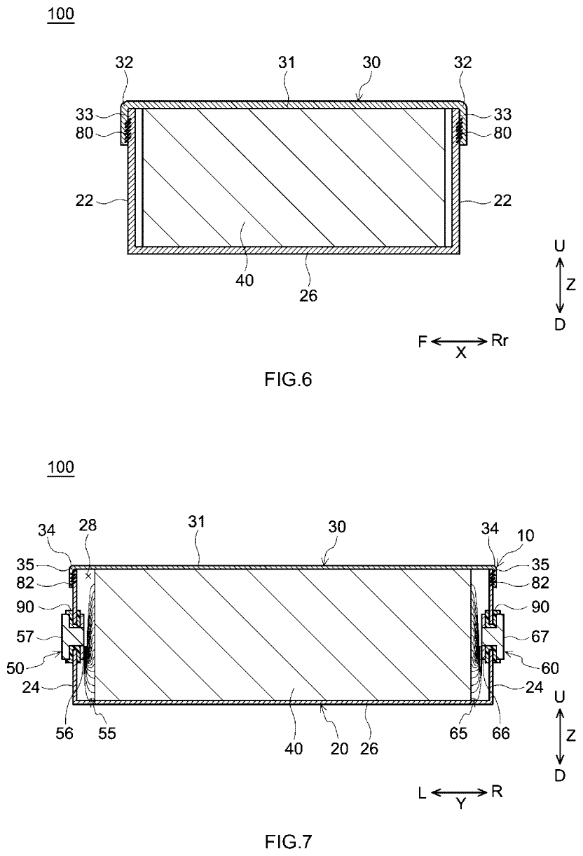

In the above-described embodiment, the first bent parts 33 of the lid 30 are joined to the inner surfaces of the first walls 22 of the case body 20. However, the configuration is not limited to such a configuration. FIG. 6 is a schematic view of an electricity storage device 100 of a modification that corresponds to FIG. 3. FIG. 7 is a schematic view of the electricity storage device 100 of the modification that corresponds to FIG. 2. As shown in FIG. 6, in the electricity storage device 100, first bent parts 33 of a lid 30 are disposed on the outer side of a case body 20. The first bent parts 33 are joined to the outer surfaces of first walls 22 of the case body 20 via first welding joining parts 80. With such a configuration, it is possible to suppress the concentration of stress on the first welding joining parts 80 and hence, the strength of a case 10 is increased. As shown in FIG. 7, in the electricity storage device 100, second bent parts 35 of the lid 30 are disposed on the outer side of the case body 20. The second bent parts 35 are joined to the outer surface of second walls 24 of the case body 20 via second welding joining parts 82. With such a configuration, it is possible to suppress the concentration of stress on the second welding joining parts 82 and hence, the strength of the case 10 is increased.

In the above-described embodiment, the electrode assembly 40 is the laminated electrode assembly having the zigzag structure that uses the belt-shaped separator 70. However, the configuration is not limited to such a configuration. For example, the electrode assembly may be a laminated electrode assembly in which a plurality of separator sheets having a substantially rectangular shape are prepared, and positive electrode plates 51 and negative electrode plates 61 are laminated with one or two or more separator sheets interposed therebetween. The electrode assembly may also be a flat wound electrode assembly in which a belt-shaped positive electrode sheet and a belt-shaped negative electrode sheet are made to overlap with each other with a belt-shaped separator sheet interposed therebetween, and are wound. In the case of the flat wound electrode assembly, a laminated part 42 is formed along, for example, a thickness direction in which the flat surfaces of the wound electrode assembly face each other.

In the above-described embodiment, one electrode assembly 40 is accommodated in the case 10. However, in some embodiments, a plurality of electrode assemblies 40 may be accommodated in the case 10.

As described above, the following items are given as specific aspects of the art disclosed herein.

Item 1: An electricity storage device including:
a case; and
an electrode assembly accommodated in the case, wherein
the case includes
   a case body having an opening that is surrounded by side walls including a pair of first walls, and
   a lid configured to seal the opening,
the electrode assembly includes a laminated part having a positive electrode and a negative electrode that are laminated in an insulated state in a direction toward the lid,
the lid includes
   a base part, and
   a pair of first bent parts extending from the base part along the pair of first walls of the case body, the pair of first bent parts facing each other, and
at least one of the pair of first bent parts is joined to at least one of the pair of first walls of the case body via a first welding joining part.

Item 2: The electricity storage device according to Item 1, in which the opening is surrounded by a pair of long sides and a pair of short sides, and
the pair of first walls forms the pair of long sides.

Item 3: The electricity storage device according to Item 2, in which the side walls further include a pair of second walls,
the pair of second walls forms the pair of short sides, and
the lid includes a pair of second bent parts extending from the base part along the pair of second walls of the case body, the pair of second bent parts facing each other.

Item 4: The electricity storage device according to Item 3, in which at least one of the pair of second bent parts is joined to at least one of the pair of second walls of the case body via a second welding joining part.

Item 5: The electricity storage device according to any one of Items 1 to 4, in which at least one of the pair of first bent parts is joined to an inner surface of the first wall of the case body via the first welding joining part.

Item 6: The electricity storage device according to any one of Items 1 to 5, in which at least one of the pair of first bent parts is joined to an outer surface of the first wall of the case body via the first welding joining part.

Item 7: The electricity storage device according to any one of Items 1 to 6, in which the base part of the lid is in direct or indirect contact with the electrode assembly in a lamination direction of the laminated part of the electrode assembly.

What is claimed is:

1. An electricity storage device comprising:
a case; and
an electrode assembly accommodated in the case, wherein
the case includes
a case body having an opening that is surrounded by side walls including a pair of first walls, and
a lid configured to seal the opening,
the electrode assembly includes a laminated part having a positive electrode and a negative electrode that are laminated in an insulated state in a direction toward the lid,
the lid includes
a base part, and
a pair of first bent parts extending from the base part along the pair of first walls of the case body, the pair of first bent parts facing each other, and
at least one of the pair of first bent parts is joined to at least one of the pair of first walls of the case body via a first welding joining part.

2. The electricity storage device according to claim 1, wherein
the opening is surrounded by a pair of long sides and a pair of short sides, and
the pair of first walls forms the pair of long sides.

3. The electricity storage device according to claim 2, wherein
the side walls further include a pair of second walls,
the pair of second walls forms the pair of short sides, and
the lid includes a pair of second bent parts extending from the base part along the pair of second walls of the case body, the pair of second bent parts facing each other.

4. The electricity storage device according to claim 3, wherein
at least one of the pair of second bent parts is joined to at least one of the pair of second walls of the case body via a second welding joining part.

5. The electricity storage device according to claim 1, wherein
at least one of the pair of first bent parts is joined to an inner surface of the first wall of the case body via the first welding joining part.

6. The electricity storage device according to claim 1, wherein
at least one of the pair of first bent parts is joined to an outer surface of the first wall of the case body via the first welding joining part.

7. The electricity storage device according to claim 1, wherein
the base part of the lid is in direct or indirect contact with the electrode assembly in a lamination direction of the laminated part of the electrode assembly.
